(19) United States
(12) Patent Application Publication
(10) Pub. No.: US 2011/0083124 A1
(43) Pub. Date: Apr. 7, 2011

(54) Software Verification Using Two-State Invariants

(75) Inventors: Michal Jan Moskal, Redmond, WA (US); Stephan Tobies, Erkelenz (DE); Ernie Cohen, Philadelphia, PA (US); Wolfram Schulte, Bellevue, WA (US)

(73) Assignee: Microsoft Corporation, Redmond, WA (US)

(21) Appl. No.: 12/575,209

(22) Filed: Oct. 7, 2009

(51) Int. Cl. G06F 9/44

(52) U.S. Cl. 717/126

(57) ABSTRACT

Software verification using two-state invariants is described. In an embodiment a verifier represents an annotated program to be verified as a plurality of atomic transitions between global program states, each state comprising a plurality of objects. For example, the verifier accesses the annotations which specify a two-state invariant for each object. A two-state invariant is a predicate that relates a global program state before a state transition to the state after that state transition. In an example some of the two-state invariants are cross-object in that they refer to other objects. For example, a verification system checks that only the two-state invariants of the objects which changed in each transition are preserved; this modularity enables the verifier to work for large code bases and concurrent software. In an example the modularity is possible since the two-state invariants meet an admissibility requirement which is independent of the functionality of the program.

### COPYRIGHT NOTICE

A portion of the disclosure of this patent contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

Automated software verification systems seek to establish the adherence of a computer program to a formal specification. Existing automated software verification systems are limited in their application and are often complex and time consuming to use.

Practically useful software verification tools are required which work in real life situations where code is typically large and complex and/or where the software is concurrent. It should be simple and straightforward for a programmer to formulate the formal specification using a suitable verification methodology and annotation language however, this is often not the case. Also, the verification system should give meaningful feedback for failed verification attempts. Generally this has not been possible and as a result, the time frames for verify and fix cycles have been unacceptably long.

The embodiments described below are not limited to implementations which solve any or all of the disadvantages of known computer-implemented software verifiers.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Software verification using two-state invariants is described. In an embodiment a verifier represents an annotated program to be verified as a plurality of atomic transitions between global program states, each state comprising a plurality of objects. It is not essential for the program itself to be object-oriented. For example, the verifier accesses the annotations which specify a two-state invariant for each object. A two-state invariant is a predicate that relates a global program state before a state transition to the state after that state transition. In an example some of the two-state invariants are cross-object in that they refer to other objects. For example, a verification system checks that only the two-state invariants of the objects which changed in each transition are preserved; this modularity enables the verifier to work for large code bases and concurrent software. In an example the modularity is possible since the two-state invariants meet an admissibility requirement which is independent of the functionality of the program.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a computer-implemented software verification system;

FIG. 2 is a flow diagram of a method of software verification;

FIG. 3 is a flow diagram of a method of software verification with example code fragments;

FIG. 4 is a flow diagram of another example method of software verification;

FIG. 5 is a flow diagram of a method of creating a ghost object referred to as a claim;

FIG. 6 is a flow diagram of a method at a computer-implemented verifier for atomic state transitions;

FIG. 7 illustrates an exemplary computing-based device in which embodiments of a computer-implemented software verifier may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a computer-implemented software verification system for verifying concurrent software, the system described is provided as an example and not a limitation. As those skilled in the art will appreciate, the present examples are suitable for application in a variety of different types of automated software verifiers.

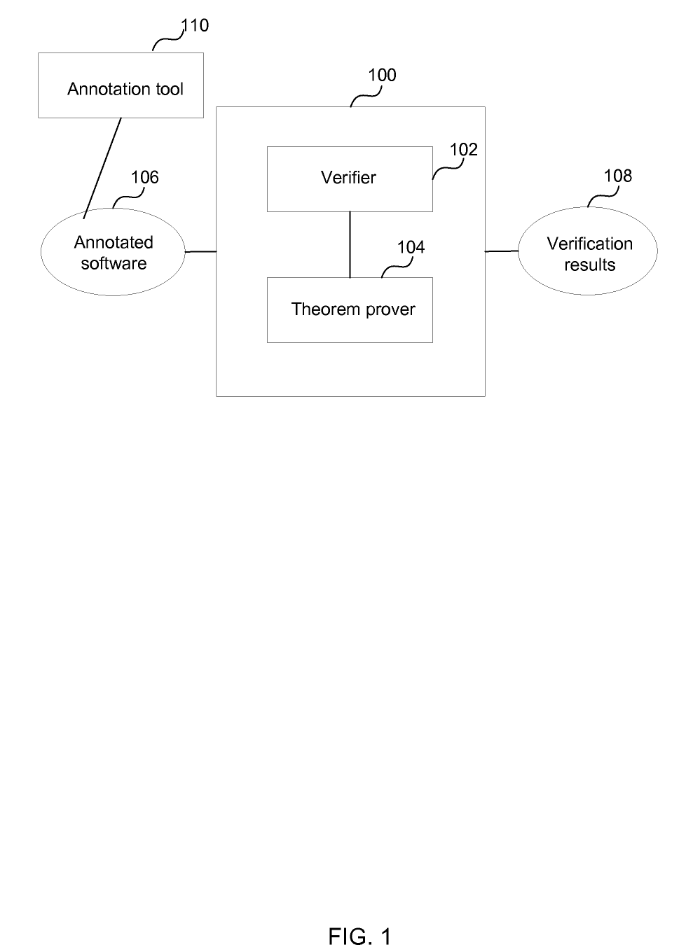

FIG. 1 is a schematic diagram of a computer-implemented verification system 100 for automatically verifying the correctness of a piece of software. The software might or might not be concurrent and/or object-oriented. The software is annotated using a suitable annotation language; the annotations specify the functionality of the software as well as aspects of its internal components, but are used only for verification and are discarded before program compilation. A non-exhaustive list of program annotations are object invariants, function pre-conditions and post-conditions, loop invariants, program assertions and assumptions. The annotations may be added to the program manually, with the use of automated software annotation tools 110, or using combinations of these approaches. The annotations may be kept separate from the code or may be embedded in the source code itself. In the case that the annotations are embedded in the source code then tools for creating the code itself may be adapted to allow the annotations to be formed. In some examples, the annotations may be at least partly inferred automatically, either by static analysis of the code or by monitory test runs of the program. The annotations can be thought of as providing guidance to the verification system 100 about the program, enabling the verifier to more easily reason about and so verify the program.

The annotations may include so-called “ghost code” in addition to other forms of annotation. Ghost code is seen by the verifier 102 of the verification system 100 and not by a compiler of the software itself. A non-exhaustive list of examples of forms of ghost code is: ghost type definitions, ghost fields, ghost variables, ghost parameters, and ghost state updates (also referred to as ghost operations).

The verification system 100 comprises an input arranged to receive annotated software 106. This annotated software comprises both the program to be verified and a formal specification of that program against which it is required to verify the program.

The verification system 100 itself comprises a verifier 102 in communication with an automated theorem prover 104. The automated theorem prover may be of any suitable type (first-order or higher-order, fully automatic or interactive, etc.) and the embodiments described herein are concerned with new verifiers 102 and new verification methodologies and annotation languages used by the new verifiers 102. The verifier 102 generates verification conditions and provides these to the automated theorem prover 104 for checking the logical validity of the verification conditions. If the automated theorem prover successfully proves the verification conditions the program is verified. The verification results 108 are provided as output of the verification system 100 and they may comprise error messages in the case of failed verification attempts together with details about the conditions in which those errors occurred.

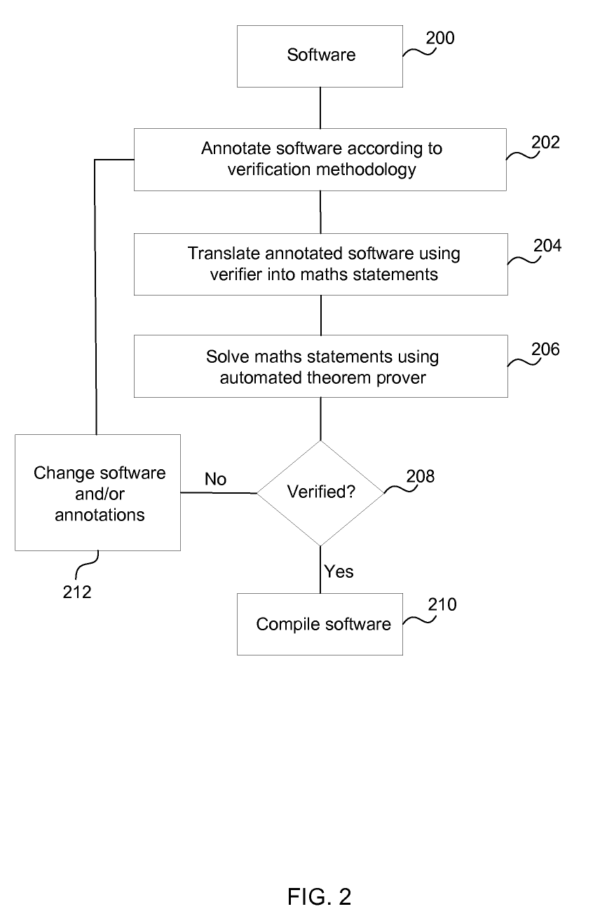

FIG. 2 is a flow diagram of a method of software verification using the verification system 100 of FIG. 1. Software 200 to be verified is accessed from any location in communication with the verification system. An annotation language tool 110 of FIG. 1 is used to annotate 202 the software according to an annotation language which is compatible with the verifier 102. The annotated software is translated 204 into mathematical statements using the verifier 102 and those mathematical statements are referred to as verification conditions. The verification conditions are provided to an automated theorem prover and an attempt to prove 206 those verification conditions is made. Additional translation steps may be made before step 206 in order that the verification conditions are in the correct format and syntax for the particular automated theorem prover 104 being used. If verification is successful at decision point 208 then the software is verified and may be compiled 210. If verification is not successful then the verification results 108 are used to change 212 the software 200 and/or the annotations. Note that the software may always be compiled. To obtain an executable it is possible to ignore the annotations and compile the program as usual.

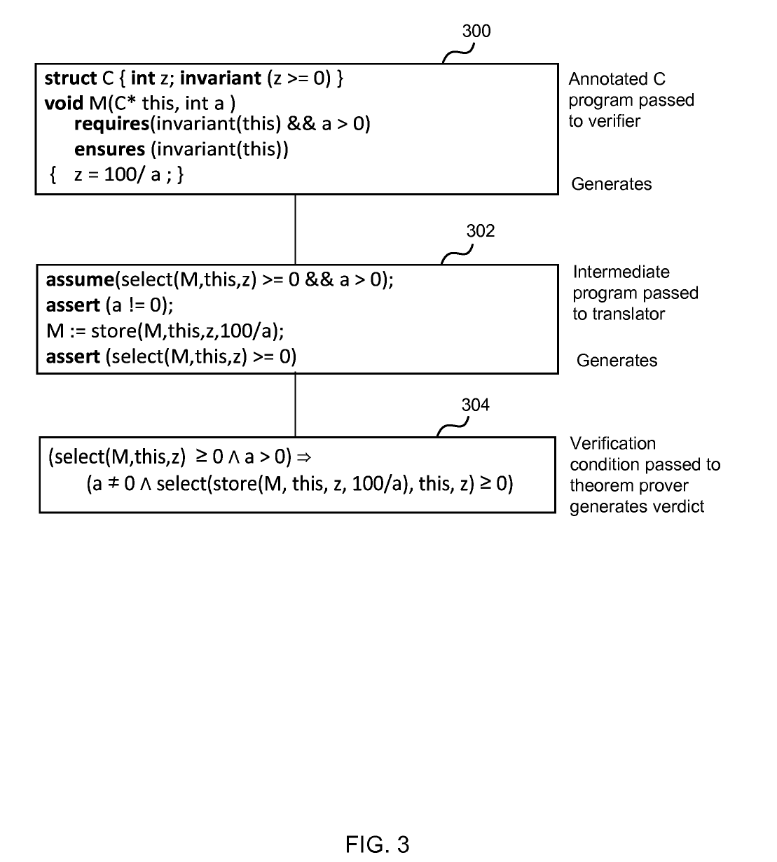

FIG. 3 shows an example annotated C program at box 300 which is used by a verification tool to generate an intermediate program 302. That intermediate program 302 is passed to another verifier which uses the intermediate program to generate a verification condition 304. That verification conditions is then passed to a theorem prover which generates a verification verdict.

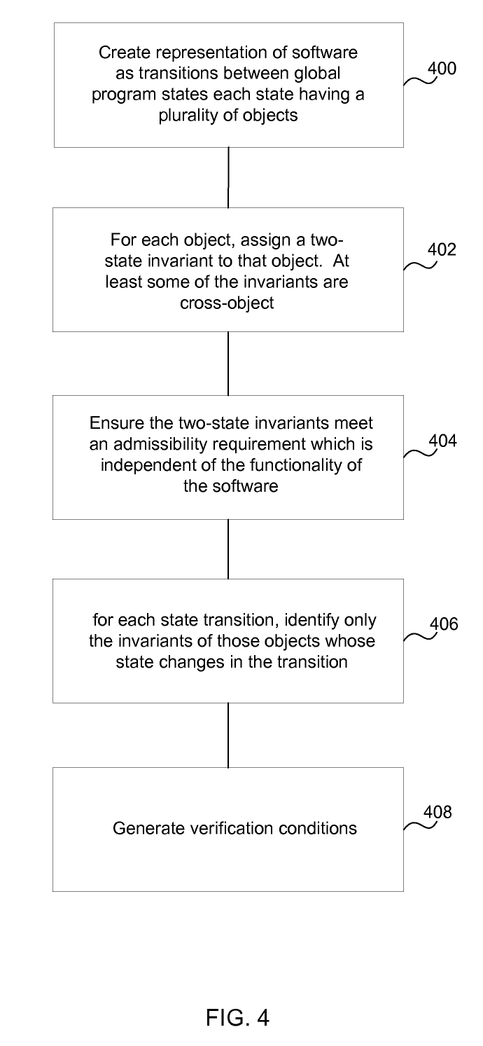

FIG. 4 is a flow diagram of a method at the verification system 100. The verifier is computer-implemented as mentioned above and it holds 400 a representation of the software as transitions between global program states each state having a plurality of objects. The transitions may for example be represented as two-state predicates describing the pairs of system states conformant with the transitions. Each object has zero or more fields which specify its state, and objects may be created and destroyed. Some of the objects may be ghost or specification objects that do not exist in the program implementation but are included to facilitate program reasoning, and objects may also have ghost fields.

Any suitable method may be used to overlay an object model on the program if required. For example, details of how to overlay an object model on a non-object oriented program such as a C program are given in Cohen et al. 2009 “A precise yet efficient memory model for C” in SSV 2009 ENTCS Elsevier Science B. V. Amsterdam which is incorporated herein by reference in its entirety.

Each object is assigned a two-state invariant 402. This assignment is known from the annotations in the annotated software. For example, some of the two-state invariants are specified in the annotation using type definitions such that any object of a given type obeys the two-state invariants for its type. A two-state invariant of an object is a predicate that relates the state of a system before a state transition (the pre-state of the transition) to the state of the system after that state transition (the post-state of the transition); such an invariant is expected to hold over all atomic transitions that begin or end during the lifetime of the object. A single-state invariant of an object is a predicate on a single state that is expected to hold in all system states encountered during the lifetime of the object; such invariants may be encoded as two-state invariants that constrain only the poststate.

The main task in verifying a program is to show that every state transition of the program satisfies all of the object invariants. This is problematic for real software systems, where it is important to minimize the dependencies between program modules. In particular, the design of a program module should be able to depend on the specifications of certain lower-level modules, but should not depend on their internal implementations (in order to allow their implementations to evolve independently), nor should it depend at all on higher-level modules (since these might not even be contemplated at the time when the low-level module is written). Thus, the verification of an update within a module should not depend on the internal invariants of lower-level modules, nor any of the invariants of higher-level modules.

In order to make verification practical, especially in the case of concurrent programs, the embodiments described herein use modular verification whereby the global program correctness follows from a plurality of local correctness checks. However, it has not previously been possible to achieve this when using two-state invariants since it is difficult to ensure that any modular verification will indeed give logically correct results.

This is particularly problematic where the verification methodology used by the verifier is highly expressive and usable. For example, in the embodiments described herein the two-state invariants assigned to the objects include at least some which are cross-object. That is, some of the objects' two-state invariants refer to one or more other objects. This enables the specification of a much larger class of programs than has previously been possible. In the case that cross-object invariants are used it is especially difficult to enable the sound verification of programs using modular verification methods.

In the embodiments described herein this is achieved by ensuring that the two-state invariants of the objects meet a particular admissibility requirement 404. This admissibility requirement depends only on the invariants and is independent of the executable statements of the software.

For example, the admissibility requirement is that: an object invariant is admissible if and only if it is preserved by every transition that preserves invariants of all modified objects. The admissibility requirement for invariants of objects is checked in any suitable manner. For example, the verifier may be arranged to generate verification conditions for passing to the automated theorem prover to carry out the admissibility requirement check. For example, this may be carried out on a type by type basis.

At the verifier, a processor selects or identifies, for each state transition, only the invariants of those objects whose state changes in the transition 406. The verifier generates and passes to an automated theorem prover 408 verification conditions sufficient to guarantee preservation of the selected invariants; if these invariants are satisfied by the transition, than all remaining object invariants are also satisfied, thanks to the admissibility condition. In this way data-modular reasoning in the presence of cross-object invariants is achieved. This enables the specification and verification of a much larger class of programs than has previously been possible without breaking the natural encapsulation boundaries of those programs.

In the examples described above the verifier is a static verifier which is used to verify software before compilation of that software. However, it is also possible to carry out static proofs of the admissibility of the invariants and combine that with run-time verification of the selected invariants. Here again, admissibility allows invariance checking to be limited to checking the invariants of modified objects.

Use of the two-state invariants described above also give the benefit that atomic updates, lock-free data structures and new ghost objects referred to as claims may be specified. This is described in more detail below.

Typically object invariants cannot hold at all times; particularly during initialization, finalization and during non-atomic updates. To capture this pattern, at least some of the embodiments described herein use a verifier which enables objects to be closed or opened. For example, each object comprises a field which indicates whether it is open or closed. Two-state invariants are required to hold only if an object is closed in either of the two states so that an invariant can be disabled as required by opening the objects (assuming that the invariant allows the object to be opened).

In some embodiments, in the case of concurrent programs threads are also treated as objects. A thread is a closed owner object which may own one or more other objects. Unwrapping/wrapping transfers ownership to/from the thread. Unwrapping/wrapping assumes/asserts the invariant of the respective object.

In some of the embodiments described herein the annotations may comprise a new type of annotation referred to herein as a claim. A claim is a ghost object which refers to one or more other objects and which is a form of guarantee that the objects it refers to will stay closed as long as the claim is closed. Claims provide a way to represent more complex object relationships than has previously been possible for automated verification. For example, claims allow the specification of admissible invariants for non-hierarchical object graphs. Software involving circular object dependencies or situations where multiple objects simultaneously depend on the state of the same object can be taken into account using claims whereas this has not previously been possible using pure ownership-based approaches. Examples of such software include operating systems, database servers, and other concurrent software that uses shared lock-free data structures.

Claims may be dynamically created or destroyed and may claim multiple objects at once in a single claim as described in more detail below. Also, claims may be claimable objects themselves.

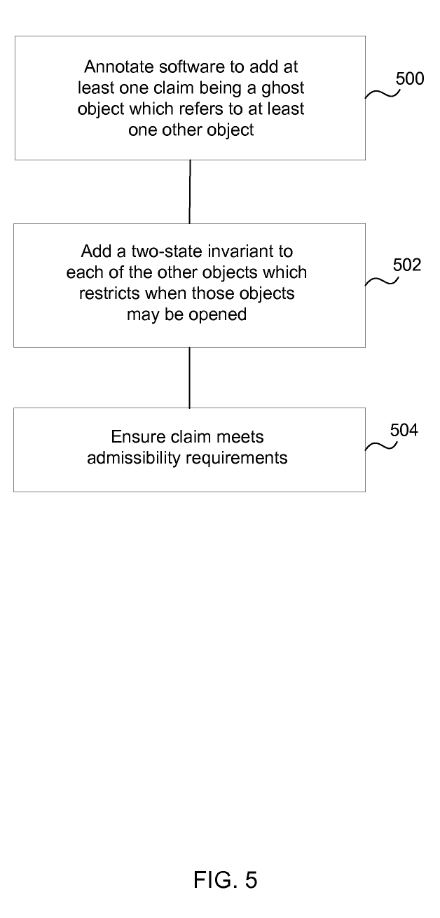

FIG. 5 is a flow diagram of a method of incorporating one or more claims in annotated code. Software is annotated 500 to add at least one claim which is a ghost object that refers to at least one other object. A two-state invariant is added 502 to each of the claimed objects which restricts when those objects may be opened. The admissibility 504 in the formation of a claim may be checked when checking the code that constructs that claim.

By owning a claim the owner of that claim has the guarantee that the claimed object(s) will not open, regardless of the actions of the actual owners of the claimed objects. As described above, claims are implemented as objects and a two-state invariant on the claimed object restricting when the claimed object can be opened. By using claims the verifier is able to guarantee interlinked knowledge about system state. Claims allow the construction of admissible invariants for many scenarios where ordinary, tree-shaped ownership hierarchies are inadequate.

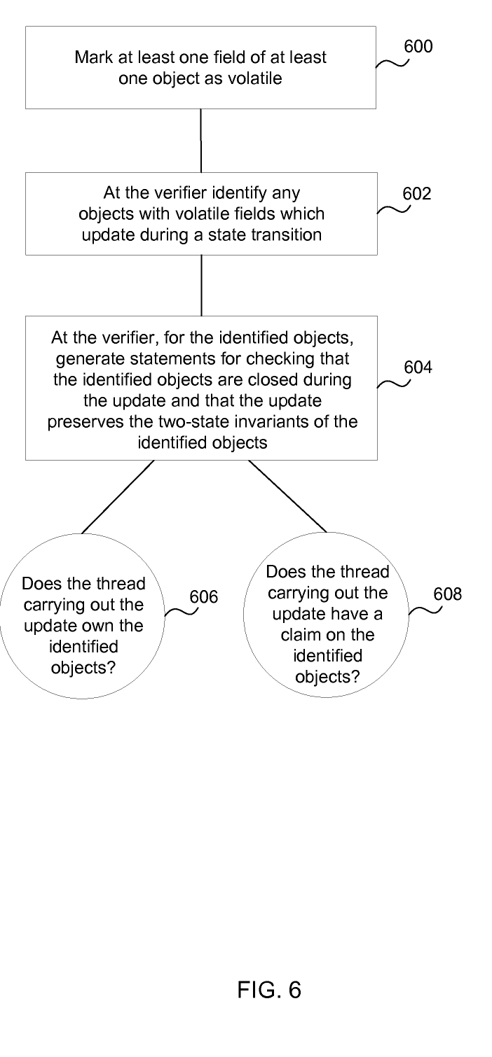

In at least some embodiments one or more of the objects have fields which are marked as volatile or sequential. In this manner the verifier is easily able to take into account atomic updates to objects in a simple and effective manner. An atomic update is one that executes or appears to execute without interruption from activities of other threads; many well-known methods for pretending that certain updates are atomic will be familiar to those skilled in the art. In the examples described herein during an atomic update an object may be modified without being opened. With reference to FIG. 6 at least one field of at least one object is marked as volatile 600. This information is known to the verifier from the program annotations. The verifier identifies 602 any objects with volatile fields that are updated during a state transition. For example, the containing objects can be provided explicitly by program annotations. Those identified updates should be atomic. Thus a processor at the verifier generates 604 verification conditions for the identified objects in order to check that the identified objects are closed during the update and that the update preserves the two-state invariants of the identified objects. For example, to achieve this, the verifier may generate verification conditions to check whether a thread carrying out the update 606 owns the identified objects and keeps them closed. In another example, the verifier may generate verification conditions to check 608 whether a thread carrying out the update can ensure that the object is closed, for example by having a claim on the object. These are examples only; there are other ways that the thread could know that the object is closed.

In this way the verifier is able to distinguish between updates to volatile and non-volatile object fields. An object's non-volatile fields can only be changed when the object has been unwrapped and is thus know to be controlled exclusively by the current thread. An object's volatile fields can be modified freely as long as the object is closed and the update preserves the two-state invariants of the object.

A detailed example of a verification methodology suitable for use by the verifier is now given.

In an example, a verifier represents a global program state as being composed of a number of disjoint objects, the state of each given by a collection of fields as described above.

Call a transition safe if it preserves all object invariants, and call a state σ safe if the stuttering transition from that state (i.e., a transition from σ to the same state σ) satisfies all object invariants. The initial state can be guaranteed to be safe by starting with all objects open. To keep reasoning modular, the verifier checks (for each program transition) only the invariants of those objects whose state changes in the transition; as mentioned above, this is potentially unsound if object invariants can mention the states of other objects. To ensure soundness the verifier also checks that all object invariants are admissible. Given a collection of invariants for each object, an object invariant is admissible if it is preserved by every transition that preserves invariants of all modified objects. Note that admissibility does not depend on the program code.

Each object has a Boolean ghost field “closed” that indicates when its invariant is expected to hold. Because two-state invariants are used, the object invariant is required to hold between two successive states only if the object is closed in at least one of them.

In some embodiments, fields of an object come in two variants, volatile and sequential (the default). The value of a sequential field can change only when the object is open, while volatile fields can change at any time (subject to the object invariants when the object is closed). Thus, for any sequential field, an object can be considered as having an additional invariant to this effect.

In the case of a concurrent program to be verified, the verifier starts from disjoint concurrency, i.e. threads operating on disjoint portions of the state; this allows ordinary, sequential reasoning within a thread. Thus, in any state, each thread “owns” some portion of the state which it is allowed to read and write; inter-thread communication thus requires some transfer of owned state between threads. This is achieved by transferring ownership using ordinary objects for this purpose (in contrast to previous approaches).

In embodiments, each object has a ghost field “owns” that maintains a set of objects that it owns. It is a system invariant that these sets and the sets of objects owned by threads form a partitioning of the set of objects, and that open objects are owned only by threads. A thread-local object is called mutable (in the context of the thread) if it is open; a thread local object is referred to as wrapped (in the context of the thread) if it is closed; a thread can only modify the non-volatile (or sequential) fields of an object when it is mutable.

As an example, consider the following definition of a spinlock in annotated C code:

```
typedef struct _LOCK {
  volatile int locked;
  spec ( obj_t prot_obj; )
  invariant( 0 == locked ==> owns [prot_obj] )
} LOCK;
```

In this example, fields in invariants are scoped to the fields of the current object type.

The type obj_t is a built-in type of typed pointers; a value of this type is a tuple consisting of an address and a type for which the address is suitably aligned. The macro “spec” indicates that its argument is ghost code included for purpose of proof but not part of the implementation. Thus, prot_obj is a ghost field of the lock. The lock uses a volatile integer field “locked” to keep track of its locked status (to be modified via atomic test-and-set operations). Finally, it has a (one-state) invariant that says that whenever the lock is available, the object protected by the lock is owned by the lock itself. Thus, the invariant above holds in the post-state of any transition for which the lock is closed in either the pre-state or the post-state. Note that because prot_obj is nonvolatile, the protected object cannot be changed as long as the lock remains closed (which, in case of a lock, is its normal state until it is eventually destroyed or used to protect a different object.)

Note that by having a generic object protected by the lock, a single lock implementation is provided that works with any protected object (which can itself own any collection of protected data, governed by any invariant).

Unwrapping an object is the process of opening a wrapped object and transferring ownership of its owned objects to the thread. Conversely, wrapping an object requires that the object is mutable, and has the effect of transferring ownership of some specified wrapped objects from the thread to the object and closing the object. Thus, a thread typically modifies a shared object by taking ownership of the object (from another object), unwrapping it, modifying it, wrapping it, and putting it back somewhere (usually in its original place).

As an example, the following implementation of the lock initialization function shows the form of function specifications and the use of wrap:

```
  void InitializeLock (LOCK *1 spec (obj_t obj) )
    requires (mutable (1) )
    requires (wrapped (obj) )
    ensures (wrapped (1) )
    ensures (1->locked == 0 && 1->prot_obj ==
obj)
    writes (1, obj)
  {
    1->locked = 0;
    spec (1->prot_obj = obj; )
    spec ( wrap (1); )
  }
```

In addition to the lock being initialized, the function takes a ghost parameter specifying the protected object. This object has to be wrapped, which means that it is owned by the current thread and is closed (hence the invariant on the protected data holds). As a post-condition, the function guarantees that the lock is wrapped, available, and bound to the protected object which (by LOCK's invariant and the aforementioned invariants) guarantees that the protected object stays closed until the lock is acquired.

Threads can meaningfully interact with shared state only if they know something about that state. Since object invariants hold only when an object is closed, useful shared state information can be obtained only from objects that are known to be closed. A thread can attempt to acquire a lock only if it knows that the lock is closed. A thread can keep objects that it owns closed, so the issue arises only for objects that are not in the ownership domain of the current thread. The ownership domain of a thread may be the set of objects transitively owned by that thread.

One approach would be to use the object invariant to prevent the object from ever being opened, but such objects could never be destroyed, which makes this approach unsuitable in the usual case where such objects are dynamically allocated and deallocated.

In some embodiments described herein claims to objects are used to address this. Such a claim is a ghost object that stores a reference to its claimed object and has the invariant that the claimed object is closed. To ensure this in a modular way where, any claimable object has an implicit ghost field that keeps track of the currently outstanding claims on that object; it also has a 2-state invariant that prevents it from going from the closed to the open state when this claims set is non-empty. As the final ingredient, the claim's invariant asserts membership in its claimed object's claims set.

More elaborate claims can be constructed by referencing more than one object at once or putting additional invariants on the claim. By creating multiple handles on a lock, multiple threads can now share the lock to gain exclusive access to its protected object:

```
  void Acquire (LOCK *1 spec (claim_t c) )
    requires (wrapped (c) && c->claimed_obj
== 1)
    ensures (wrapped(1->prot_obj) )
    ensures (! old (owns (me) [1-
  >prot_obj] ) ) ;
  void Release (LOCK *1 spec (claim_t c) )
    requires (wrapped (c) && c->claimed_obj
== 1)
    requires (wrapped (1->prot_obj) )
    writes (1->prot_obj) ;
```

Note how Acquire requires, as a ghost parameter, a claim that guarantees that the lock is closed. It ensures that the protected object is wrapped, which implies that it is now owned by the current thread (that has just completed the call to Acquire) and closed, thus its invariant holds. Also, by guaranteeing that the protected object has not been in the owns set of the current thread (represented by owns(me)), the current thread is free to change the object without interference with the rest of its ownership domain.

Dually, Release requires a claim on the lock and the protected object to be wrapped and ensures that the protected object is no longer a member of the ownership domain of the current thread. Note that Release does not ensure that the lock is unlocked. Indeed, depending on the scheduling, another thread could have acquired the lock after the current thread's release but before returning from the call to Release.

This example uses claims in a simple form. In addition to guaranteeing that its claimed objects are closed, a claim can state properties of the system state. The admissibility check for such properties amounts to checking that it is true at the time the claim is closed, and is preserved by changes to other objects (typically making use of the fact that the referenced objects remain closed).

For example, when a thread reads (or writes and retains information about) a shared variable, it can construct a claim that captures whatever information it needs to retain from this access. Thereafter, it doesn't have to recheck this information (even if it writes to shared state) until it chooses to destroy the claim. By making claims explicit objects, they can be put inside of other objects, allowing arbitrary interlinking of knowledge about the system state.

The implementation of claims inside the verification system is described in more detail below.

In some embodiments atomic updates are implemented by using volatile fields of objects. In examples, atomic updates are enabled which allow a thread to modify volatile fields of objects without necessarily owning the objects. The update requires that the modified objects are closed (e.g., by owning the objects or having claims on them), and also requires that the update preserves the 2-state invariants of the modified objects.

This is illustrated by the following implementation of Acquire. It spins, attempting in each operation to change the locked field of the lock from 0 to 1 in an atomic test-and-set operation. When it finds that the bit has been successfully changed (i.e., if the bit was 0 before the operation, as indicated by the return value of the test-and-set operation), ownership of the protected object is moved from the lock to the current thread (by assigning false to l→owns[l→prot_obj]) and the loop is terminated.

```
  int acquired = 0;
  do {
    atomic (1) {
      if (!InterlockedBitTestAndSet (&1-
    >locked, 0) ) {
          acquired = 1;
        spec(1->owns[1->prot_obj] =
fale); ); )
      }
    }
  } while (!acquired) ;
```

The argument to the atomic block (l in the example) gives the set of objects whose volatile fields can be modified in the block. These objects are required to be closed, and their invariants are checked across the atomic transition.

Within each thread, execution is broken down into a sequence of actions, each of which preserves all object invariants. However, since reasoning in the context of a thread may involve formulas that mention the states of objects not owned by the thread, reasoning is made easier by minimizing the number of places at which it is required to consider the possibility of another thread changing the state. When reasoning within a thread, the verification system considers the possibility of interruption only when the thread is about to communicate with other threads by reading or writing data outside its ownership domain. It is shown that this reasoning is sound, even if the program is run under a scheduler that can interrupt the thread at any time.

To describe more precisely the proof obligations generated in verification, a verification method is described for a simplified language, syntax of which is given below. The language is stripped of control flow structures; these can easily be added. Function calls are omitted for clarity: handling of function calls in the implementation is described in more detail later in this document.

Syntax:

| | |
|---|---|
| fields | f ∈ F ::= field\|f′ |
| variables | χ ∈ V ::= var\|χ′ |
| expressions | e ::= χ\|e₀∪e₁\|e₀ \e₁\|{e₀,...,eₙ} |
| reads | r::= χ:=e\|χ:=e→f |
| updates | u::=e₀→f := e₁ |
| actions | a ::= r\|alter e with ū |
| steps | s ::= a\|atomic ā |
| | ū ::= u;ū \|∈ |
| | ā ::= a;ā \|∈ |
| | s̅ ::= s; s̅ \|∈ |

A program in the language is defined by specifying the sequence of steps (s) for each thread. Each step is either an action or a sequence of actions grouped in an atomic block. Each action is either a read or a sequence of updates grouped using an alter block (which additionally specifies the set of updated objects); each action preserves all object invariants when executed atomically.

Expressions (e) include variable references and set operations.

Semantics

For simplicity of exposition, a single data type P represents an infinite enumerable set of pointers. Since for some purposes it is required to interpret pointers as sets, assume a bijection S from pointers to finite sets of pointers.

The semantics of the language is defined in terms of transitions between configurations [symbol] σ,T [symbol] , where each configuration consists of a heap σ:P×F→P and a function T that maps each thread to a local environment and a continuation, i.e. T(t)= [symbol] ε, s̅ [symbol] where ε:V→P is thread t's local environment and s̅ are the remaining steps of thread t.

$$[ x ] ɛ = ɛ ( x ) \\ [ {e}_{0} ⋃ {e}_{1} ] ɛ = {S}^{- 1} ( S ( [ {e}_{0} ] ɛ ) ⋃ S ( [ {e}_{1} ] ɛ ) ) \\ [ {e}_{0} \backslash {e}_{1} ] ɛ = {S}^{- 1} ( S ( [ {e}_{0} ] ɛ ) \backslash S ( [ {e}_{1} ] ɛ ) ) \\ [ \{ {e}_{0} , … , {e}_{n} \} ] ɛ = {S}^{- 1} ( \{ [ {e}_{0} ] ɛ , … , [ {e}_{n} ] ɛ \} )$$

$$\frac{ɛ , W ← \text{<} σ [ [ {e}_{0} ] ɛ , f := [ {e}_{1} ] ɛ ] , \overline{u} > {\to }_{t}^{*} {σ}^{1} [ {e}_{0} ] ɛ ∈ W}{ɛ , W ← 〈 σ , {e}_{0} \to f := {e}_{1} ; \overline{u} 〉 {->}_{t}^{*} {σ}^{1}} ɛ , \overline{W ← 〈 σ , ∈ 〉 {\to }_{t}^{*} σ}$$

$$\frac{\begin{matrix}{alter}_{1} ( t , A , [ e ] ɛ , σ ) ɛ , [ e ] ɛ ← 〈 σ , \overline{u} 〉 {\to }_{t}^{*} {σ}^{1} \\ {alter}_{2} ( t , A , [ e ] ɛ , σ , {σ}^{1} ) good ( σ , {σ}^{1} )\end{matrix}}{〈 〈 σ , ɛ 〉 , alter e with \overline{u} 〉 {⊳}_{t , A} 〈 {σ}^{1} , ɛ 〉}$$

$$\overline{〈 〈 σ , ɛ 〉 , x := e 〉 {⊳}_{t , A} 〈 σ , ɛ \vert x := [ e ] ɛ ] 〉} \frac{readable ( t , A , σ , 〈 [ e ] ɛ , f 〉 )}{〈 〈 σ , ɛ 〉 , x := e \to f 〉 {⊳}_{t , A} 〈 σ , ɛ \vert x := σ ( [ e ] ɛ , f ) 〉}$$

$$\frac{〈 〈 σ , ɛ 〉 , a 〉 {⊳}_{t , A} 〈 {σ}^{′} , {ɛ}^{′} 〉 〈 〈 {σ}^{′} , {ɛ}^{′} 〉 , \overline{a} 〉 {⊳}_{t , A}^{*} 〈 {σ}^{″} , {ɛ}^{″} 〉}{〈 〈 σ , ɛ 〉 , a ; \overline{a} 〉 {⊳}_{t , A}^{*} 〈 {σ}^{″} , {ɛ}^{″} 〉} \overline{〈 〈 σ , ɛ 〉 , ∈ 〉 {⊳}_{t , A}^{*} 〈 σ , ɛ 〉} \\$$

$$\frac{T ( t ) = 〈 ɛ , atomic \overline{a} ; \overline{s} 〉 〈 〈 σ , ɛ 〉 , \overline{a} 〉 {⊳}_{t , 1}^{*} 〈 {σ}^{′} , {ɛ}^{′} 〉}{〈 σ , T 〉 {⊳}_{t} 〈 {σ}^{′} , T [ t := 〈 {ɛ}^{′} , \overline{s} 〉 ] 〉} \frac{T ( t ) = 〈 ɛ , a ; \overline{s} 〉 〈 〈 σ , ɛ 〉 , a 〉 {⊳}_{t , 0} 〈 {σ}^{′} , {ɛ}^{′} 〉}{〈 σ , T 〉 {⊳}_{t} 〈 {σ}^{′} , T \vert t := 〈 {ɛ}^{′} , \overline{s} 〉 〉}$$

The thread-specific transition relation [symbol] σ,T [symbol] [symbol] ₜ [symbol] σ′,T′ [symbol] defined above describes the effect of running a single step of thread t on state [symbol] σ,T [symbol] . It selects the environment and the next action of the thread t from T and executes it according to either [symbol] _{t,0} or [symbol] _{t,1} depending on whether execution is inside or outside of an atomic block. The 0/1 flag is used in side conditions checked when reading or writing the state.

The conditions alter₁( . . . ),alter₂( . . . ),good( . . . ) and readable( . . . ) are used to enforce the methodology. If an execution fails to satisfy either of those conditions, it is said to go wrong, that is reach a special configuration ⊥.

Definitions of those side conditions require introduction of a few functions constituting the system invariants.

Predicate thread(p) is true if given pointer represents a thread. Predicate volatile(p, f) is true if field f of p is to be considered volatile, i.e. is allowed to change without the object p being opened (see definition of non vol( . . . ) for details). Both are state independent and in the implementation are derived from type definitions. Whenever a variable t is used (possibly with indices) implicitly assume thread(t).

The predicate closed(σ,o), stating that o is closed in state σ, is defined as σ(o,closed)=1, where 1 is treated as a distinguished element of P. Similarly, define the owns set function owns(σ,o) as S(σ(o,owns)).

The ownership domain of p in state σ is the minimal solution to domain(σ,p)={p}∪

(∪q: [symbol] volatile(p,owns) [symbol] q ∈ owns(σ,p):domain(σ,q))

The partition of thread t in σ (written partition(σ,t)) is defined as the set of those [symbol] p,f [symbol] such that

p ∈ domain(σ,t) [symbol] ( [symbol] volatile(p,f) [symbol] [symbol] closed(σ,p))

The shared portion of state σ is everything outside any partition:

shared(σ)={ [symbol] p,f [symbol] | [symbol] ∃t. [symbol] p,f [symbol] ∈ partition(σ,t)}

The condition readable(t,A,σ,l) under which a thread is allowed to read data is

l ∈ partition(σ,t) [symbol] (A [symbol] l ∈ shared(σ))

In other words, a thread is allowed to read its partition, and can also read shared data when inside an atomic block.

The conditions for writing are three-fold. First the verification system requires to make sure the current thread either owns the data it is going to write or it is running atomically and the object written is closed, i.e. alter₁(t,A,W,σ) is:

∀p ∈ W.(A [symbol] closed(σ,p)) [symbol] p ∈ owns(σ,t)

Second, the thread is not allowed to open or close objects outside of its owns set nor to change its partition (by opening or closing an object with volatile fields) which outside of an atomic block, i.e. alter₂(t,A,W,σ,σ′) is:

∀p ∈ W.closed(σ,p)≠closed(σ′,p) [symbol] p ∈ owns(σ,t) [symbol] (A [symbol] ∀f. [symbol] volatile(p,f))

Finally it is required to ensure that the update preserves higher-lever system invariants as well as object invariants, that is (σ,σ′) is defined as:

closed*(σ′) [symbol] non_vol(σ,σ′,S) [symbol] inv_{≠}(σ,σ′)

The predicate closed*(σ) stating the interactions between the closed and owns fields is defined as conjunction of:
1. ∀p,q.closed(σ,p) [symbol] closed(σ,q) (if your are closed the everything you own is closed)
2. ∀p. [symbol] thread(p) [symbol] [symbol] closed(σ,p)=Ø (ordinary open objects cannot own anything)
3. ∀p,thread(p) [symbol] [symbol] closed(σ,p) [symbol] p ∈ owns(σ,p) (threads cannot be closed and own themselves)
4. ∀p,q.owns(σ,p)∪owns(σ,q)≠Ø [symbol] p=q (owns sets are disjoint)
5. ∀p, ∃q, p ∈ owns(σ,p) (everyone is owned)

The last two conditions amount to saying that there exists an owner(σ,o) function giving the only object in owns set of which o is contained.

The predicate non_vol(σ,σ′) says that the non-volatile fields of closed objects did not change:

∀p,f.closed(σ,p) [symbol] closed(σ′,p) [symbol] [symbol] volatile(p,f) [symbol] σ(p,f)=σ′(p,f)

Finally the predicate inv≠(σ,σ′) says that the two-state invariants of objects changed by the alter block has been preserved:

∀p.closed(σ,p) [symbol] closed(σ′,p) [symbol] σ=ₚσ′ [symbol] inv(σ,σ′,p)

where σ=ₚσ′ is defined as (∀f.σ(p,f)=σ′(p,f)).

The predicate inv(σ,σ′,p) is the two-state invariant for pointer p. In embodiments, this is calculated from the type declaration of p.

Admissibility

DEFINITION 1. The invariant of object p is admissible if for any σ and σ′ if:
1. σ=ₚσ′:
2. non_vol(σ,σ′)
3. closed(σ′,p)
4. ∀o.closed(σ,o) [symbol] inv(σ,σ,o);
5. inv≠(σ,σ′); and
6. closed*(σ) [symbol] closed*(σ′),
then
1. closed(σ,p) [symbol] inv(σ,σ′,p)(stability); and
2. inv(σ,σ′,p) [symbol] (σ′,σ′,p)(stuttering).

The verification system requires proof (from type and invariant declarations alone) that all invariants declared on types are admissible. Henceforth we assume that all invariants are admissible.

Let sin v₂(σ,σ′)=∀p.closed(σ,p) [symbol] closed(σ′,p) [symbol] inv(σ,σ′,p), i.e., the invariants of all closed objects hold between σ and σ′. Let sin v₁(σ)=closed*(σ) [symbol] inv(σ,σ) be the invariant that every state of execution will fulfill.

If all invariants are admissible, it is only required to check invariants of objects that were updated:

LEMMA1. If sin v₁(σ) and good(σ,σ′) then sin v₂(σ,σ′) and sin v₁(σ′).

Because checking of closed*( . . . ) can be difficult in general, the wrap and unwrap operations are used that, under certain conditions, are guaranteed to maintain closed*. Wrap and unwrap are presented to the user as the only way of opening and closing objects. They are defined as:

| | |
|---|---|
| wrap e₀,e₁ = | unwrap e₀ = |

| | |
|---|---|
| tmp := me→owns | tmp₀ := e₀→owns |
| alter{e₀,me}with | tmp₁ :=me→owns |

| | |
|---|---|
| e₀→owns := e₁ | alter {e₀,me} with |

| | |
|---|---|
| me→owns := tmp \ e₁ | e₀→owns :={ } |
| e₀→closed := 1 | me→owns :=tmp₀∪tmp₁ |

e₀→closed :=0

where the variable me refers to the current thread.

Additionally two operations are introduced to move an object e₀ in and out of a volatile owns set of another object e₁. The object e₀ is moved to/from the owns set of the current thread:

| | |
|---|---|
| put e₀ in e₁ = | remove e₀ from e₁ = |

| | |
|---|---|
| tmp₀:= me→owns | tmp₀:= me→owns |
| tmp₁:= e₁→owns | tmp₁:= e₁→owns |
| alter{e₁,me}with | alter{e₁,me}with |

| | |
|---|---|
| me→owns :=tmp₀\{e₀} | me→owns := tmp₀∪{e₀} |
| e₁→owns :=tmp₁∪{e₀} | e₁→owns : = tmp₁\{e₀} |

Both need to be executed inside of an atomic block and require e₀ and e₁ to be closed. Additionally e₁ is required to have a volatile owns field. The put operation additionally requires the object e₁ to be in the owns set of the current thread, while the remove requires it to be in the owns set of e₀. Again, checking that the invariant of e₀ allows adding/removing a child is a proof obligation.

Claims

A type definition has the form type t={ F̅} where:

F̅::=volatile f; F̅|f; F̅|∈
It is syntactic sugar for introducing a predicate t defined on pointers and constraining the volatile( . . . ) function so for type t={ . . . ; volatile f; . . . } there is t(p) [symbol] volatile(p,f) and for type t={ . . . ; f; . . . } there is t(p) [symbol] [symbol] volatile(p,f).

Consider the following type definitions:

type Data={volatile H} type Handle={p}

The idea is that if you own a h such that Handle(h) you can rest assured that the σ(h,F) will stay closed (where presumably Data(σ(h,P))). To make sure Data knows about it the system includes a set of active handles in it. The inv(σ₀,σ,h) will imply:

Handle(h) [symbol] h ∈ σ(σ(h,P),H) [symbol] closed(σ,σ(h,P))

To make this invariant admissible it is required to also restrict changes to the data, i.e. the inv(σ₀,σ,d) should imply:

Data(d) [symbol] (∀h.closed(σ,h) [symbol] (h ∈ σ(d,H) [symbol] σ(h,P)=d)) [symbol] (closed(σ₀,d) [symbol] [symbol] closed(σ,d) [symbol] σ(d,H)=Ø) [symbol] (∀o. [symbol] thread(o) [symbol] p ∈ owns(σ,o) [symbol] σ₀(d,H)=σ(d,H) [symbol] inv(σ₀,σ,o))

Note that there is a possible circularity problem with a dependency of inv(σ₀,σ,d) on inv(σ₀,σ,o). To guarantee consistency, such terms can occur only with positive polarity in object invariants.

The owner of the data can control the handle set, for example given: type Ctrl={D;H] where inv(σ₀,σ,c) implies:

Ctrl(c) [symbol] σ(c,D) ∈ owns(σ,c) [symbol] σ(σ(c,D),H)=σ(c,H)

That is the controller includes a non-volatile copy of the handle set.

Because the invariant of the Data says that whenever changing its handle set it will check with the invariant of the owner, the invariant of Ctrl is admissible.

For example to create a handle h, given a wrapped controller c.
atomic
   d:=c→D
   h→P:=d
   unwrap c
   alter {d} with
      tmp:=d→H
      d→H:=tmp∪{h}
      c∝3H:=tmp∪{h}
   wrap h, { }
   wrap c, {d}

The inclusion of the handle set in the Ctrl allows for restriction on creation of new handles. This is used to implement concurrency primitives like reader-writer locks. Whenever a new reader lock is acquired, a new handle is created and given out to the caller. When the reader lock is released, the caller needs to give back the handle, which is opened up and removed from the handle set. This way the volatile integer counting the number of reader locks is tied to the cardinality of the handle set, and thus if it is zero the Data can be open (and for example given out to a caller acquiring a writer lock).

A claim builds on top of a handle. It is an object owning one or more handles. When checking admissibility of invariant of the claim it is possible to rely on the fact that the objects to which handles are held are closed, and thus respect their invariants. Because the claim is first closed in a particular state, the invariant of the claim can depend on some properties of that state. One example would be that a claim on an object with a field that can never decrease could have an invariant guaranteeing the value to be at least the value at the time when the claim was taken.

An example implementation includes claims as built-ins to allow for creation of claims in the running code of a function. This overcomes some practical problems, where parts of the local state would need to be copied to fields of claim, so they can be mentioned in the invariants. There is however no theoretical reason to do that—the methodology primitives are strong enough to implement claims.

An example implementation allows functions with pre-, post-conditions and writes clauses. The interpretation of the pre- and post-conditions is standard. The function is allowed to write to the sequential ownership domain of objects listed in its writes clause, as defined before the call. This is enforced by maintaining a ghost variable with the set of currently writable objects. The set is initialized to the writes clause, and when unwrapping o, the owns set of o is added to the writes clause. Upon writing to p the function is required to check that p is in the writes set and is owned by the current thread. This way the wrap operation does not need to shrink the writes set.

The writes set is however not consulted when performing writes to the shared state in the atomic block—these are always allowed (as permitted by invariants). On the other hand, if an atomic operation causes objects to be moved into owns set of the current thread, such objects are also added to the writes set. This is a generalization of object allocation (moving it from the ownership domain of the memory allocator to the ownership domain of the current thread).

In an example, verification conditions (VCs) are generated for each method. They state that if the configuration [symbol] σ,T [symbol] where T(t)= [symbol] ε, s̅ [symbol] where s̅ is the body of the function and σ and ε satisfy the preconditions of the function, then the state ⊥ will not be reached by the transition of thread t, executed under a coarse scheduler. The VCs explicitly check invariants of changed objects, as well as readable( . . . ) and alter₁( . . . ) but the closed*( . . . ) predicate is enforced by the wrap/unwrap protocol. The VCs assume sin v₁( . . . ) to hold before every transition.

The proposed verification methodology is equally applicable to sequential code, which can simply be perceived as a concurrent program with just a single thread of execution. In the sequential case, the notion of atomicity can be relaxed as there are no threads that execute concurrently.

In practical usage, the methodology often requires a high-level object to make use of a field of a low-level object in its invariant. For example, a low-level object implementing an abstract set data structure might be used as part of a higher-level data structure. In this case, some modifications to the low-level object might break the invariant of the higher-level object, making the high-level object invariant inadmissible. Admissibility can be restored by giving the low-level object an additional invariant that calls for a check of the invariant of the high-level object on such changes to the state of the low-level object. In such cases, the invariant of the high-level object might not be available when verifying some updates to the low-level object. In such cases, updates to the low-level data object can be verified by providing as ghost parameters additional claims that guarantee that the desired updates do not break the invariant of the high-level object.

The proposed verification methodology can be applied even if a single atomic action requires updates to state residing in different modules. Typically, this happens when an update to the low-level object has to be accompanied by a corresponding “compensation” update to the high-level object. In this case, the higher-level code can check that it is able to add such compensation to a low-level action satisfying some specification and preserving some invariants to create a combined action satisfying some higher-level specification and invariants as well. The existence of such ghost compensation can be encoded as a claim, and passed to the function performing the low-level update, serving as “permission” for it to perform the update and concomitant compensation. More sophisticated forms of permission can be made by replacing the claim with a more general ghost object with additional state components, allowing the compensation to follow a prescribed protocol.

The proposed verification methodology has been implemented in an automated, sound C verifier being used to verify the functional correctness of a virtual machine monitor.

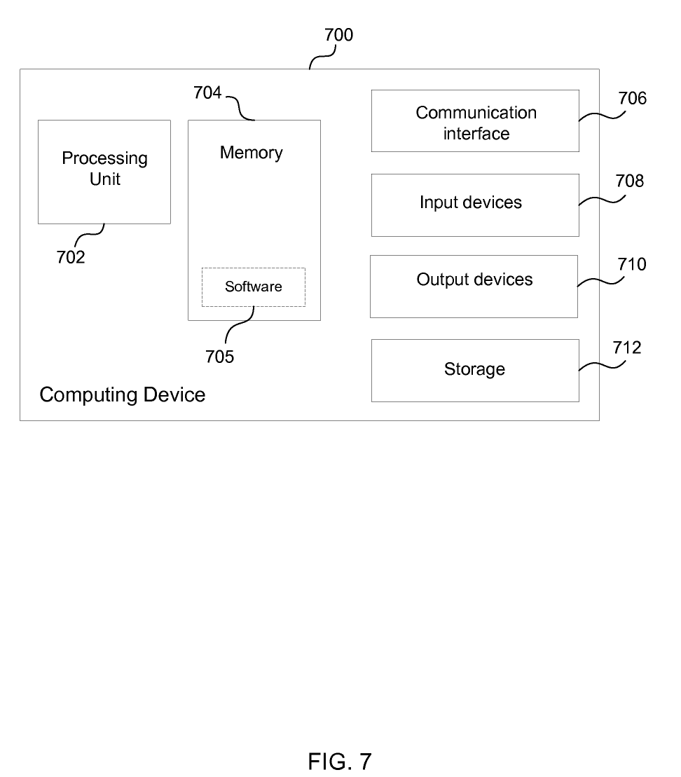

FIG. 7 illustrates various components of an exemplary computing-based device 700 which may be implemented as any form of a computing and/or electronic device, and in which embodiments of an automated verifier for verifying programs may be implemented.

The computing-based device 700 comprises one or more inputs 708 which are of any suitable type for receiving media content, Internet Protocol (IP) input, annotated programs, program specifications, files or other input. The device also comprises communication interface 706 to enable the device to communicate with other devices over a communications network.

Computing-based device 700 also comprises one or more processors at a processing unit 702 which may be microprocessors, controllers or any other suitable type of processors for processing computing executable instructions such as software 705 to control the operation of the device in order to verify software.

The computer executable instructions may be provided using any computer-readable media, such as memory 704. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

An output 710 is also provided such as an audio and/or video output to a display system integral with or in communication with the computing-based device. The display system may provide a graphical user interface, or other user interface of any suitable type although this is not essential. The output is also arranged to provide verification conditions to be used as input to an automated theorem prover. Storage 712 is also provided which may be memory of any suitable type.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A computer-implemented verifier arranged to verify whether a program meets a program specification, the verifier comprising:
an input arranged to receive the program specification as a version of the program comprising annotations;
a processor arranged to represent the annotated program as a plurality of transitions between global program states, each state comprising a plurality of objects;
the processor also arranged to access the annotations, at least some of which specify a two-state invariant for some of the objects, a two-state invariant being a predicate that describes a set of pairs of system states; wherein at least one of the two-state invariants mentions the state of another object; and wherein the two-state invariants meet an admissibility requirement which is independent of the functionality of the program; and
the processor being arranged, for each transition to select only the invariants of those objects whose state changes in that transition;
the processor also being arranged to use the selected invariants to generate verification conditions for input to an automated theorem prover to check that the program specification is met in a logically sound manner.

2. A verifier as claimed in claim 1 wherein the processor accesses the two-state invariants such that they meet the following admissibility requirement: an invariant is admissible if and only if it is preserved by every transition that preserves invariants of all modified objects.

3. A verifier as claimed in claim 1 wherein the program is a concurrent program.

4. A verifier as claimed in claim 1 wherein the processor is arranged to generate the verification conditions such that the automated theorem prover is able to check that each transition preserves the selected invariants.

5. A verifier as claimed in claim 1 wherein the processor is arranged to generate verification conditions to ensure that the two-state invariants meet the admissibility requirement.

6. A verifier as claimed in claim 1 wherein the processor is arranged to represent the objects as either open or closed and whereby the processor is arranged to select, for a given transition, only invariants of objects which are closed in either of the states before and after the transition.

7. A verifier as claimed in claim 6 wherein the processor is arranged to access annotations which comprise at least one claim which is an object which refers to at least one other object; and where the processor is arranged to access from the annotations an opening-restriction two-state invariant for each of the other objects to which the claim refers.

8. A verifier as claimed in claim 1 wherein the processor is arranged to represent each object as comprising a plurality of fields; at least some of the objects having at least one field marked as volatile; and wherein the processor is arranged to identify any objects having volatile fields which update during a transition.

9. A verifier as claimed in claim 8 wherein the processor is arranged to generate verification conditions for checking that the identified objects having volatile fields are closed during the update and that the update preserves the two-state invariants of those identified objects.

10. A computer-implemented verifier arranged to verify whether a concurrent program meets a program specification, the verifier comprising:
an input arranged to receive the program specification as a version of the concurrent program comprising annotations;
a processor arranged to represent the annotated concurrent program as a plurality of transitions between global program states, each state comprising a plurality of objects;
the processor also arranged to access the annotations, at least some of which specify a two-state invariant for some of the objects, a two-state invariant being a predicate that describes a set of pairs of system states; wherein at least one of the two-state invariants mentions the state of another object; and
wherein the two-state invariants meet an admissibility requirement which is independent of the functionality of the program; the admissibility requirement being: an invariant is admissible if and only if it is preserved by every transition that preserves invariants of all modified objects; and
the processor being arranged, for each transition to select only the invariants of those objects whose state changes in that transition;
the processor also being arranged to use the selected invariants to generate verification conditions for input to an automated theorem prover to check that the program specification is met in a logically sound manner.

11. A verifier as claimed in claim 10 wherein the processor is arranged to generate the verification conditions and input those to the automated theorem prover at run-time.

12. A verifier as claimed in claim 10 wherein the processor is arranged to generate the verification conditions such that the automated theorem prover is able to check that each transition preserves the selected invariants.

13. A verifier as claimed in claim 10 wherein the processor is arranged to represent the objects as either open or closed and whereby the processor is arranged to select, for a given transition, only invariants of objects which are closed in either of the states before and after the transition.

14. A verifier as claimed in claim 13 wherein the processor accesses the annotations comprising at least one claim which is an object which refers to at least one other object; and where the annotations comprise an opening-restriction two-state invariant for each of the other objects to which the claim refers.

15. A verifier as claimed in claim 10 wherein the processor is arranged to generate verification conditions to ensure that the two-state invariants meet the admissibility requirement.

16. A method of verifying that a program meets a program specification comprising the steps of:
at an input receiving the program specification as a version of the program comprising annotations;
at a processor representing the annotated program as a plurality of transitions between global program states, each state comprising a plurality of objects;
at the processor accessing the annotations, at least some of which specify a two-state invariant for some of the objects, a two-state invariant being a predicate that describes a set of pairs of system states; wherein at least one of the two-state invariants mentions the state of another object; and wherein the two-state invariants meet an admissibility requirement which is independent of the functionality of the program; and
at the processor, for each transition, selecting only the invariants of those objects whose state changes in that transition;
at the processor using the selected invariants to generate verification conditions for input to an automated theorem prover to check that the program specification is met in a logically sound manner.

17. A method as claimed in claim 16 comprising: accessing the two-state invariants such that they meet the following admissibility requirement: an invariant is admissible if and only if it is preserved by every transition that preserves invariants of all modified objects.

18. A method as claimed in claim 16 comprising generating verification conditions where the program is a concurrent program.

19. A method as claimed in claim 16 comprising using the processor to generate the verification conditions such that the automated theorem prover is able to check that each transition preserves the selected invariants.

20. A method as claimed in claim 16 comprising: at the processor generating verification conditions to ensure that the two-state invariants meet the admissibility requirement.
